(19) United States
(12) Patent Application Publication
(10) Pub. No.: US 2009/0052921 A1
(43) Pub. Date: Feb. 26, 2009

(54) IMAGE FORMING APPARATUS, CLEANING METHOD AND CLEANING PROGRAM

(75) Inventor: Kazuhiro Nishiwaki, Shizuoka-ken (JP)

Correspondence Address: AMIN, TUROCY & CALVIN, LLP, 127 Public Square, 57th Floor, Key Tower, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 12/137,734

(22) Filed: Jun. 12, 2008

Related U.S. Application Data
(60) Provisional application No. 60/957,322, filed on Aug. 22, 2007.

(51) Int. Cl. G03G 15/16

(52) U.S. Cl. 399/66; 399/101

(57) ABSTRACT

There is provided a technique in which a cleaning process of a developer attached on a transfer roller can be effectively realized. There are included an instruction reception unit 103 to receive information relating to an execution instruction of cleaning of a transfer roller 702, a sheet supply control unit 104 to perform sheet supply in a case where the instruction reception unit 103 receives the information relating to the execution instruction of a cleaning mode, a timing determination unit 105 to determine a timing when a sheet supplied by the sheet supply control unit 104 exists at a specified transfer position, and a voltage control unit 106 to alternately switch between a voltage of a first polarity and a voltage of a second polarity opposite to the first polarity and to apply the voltages to the transfer roller at the timing, which is determined by the timing determination unit 105, when the sheet exists at the specified transfer position P.

### BACKGROUND OF THE INVENTION

1. Field of the Invention

The present invention relates to a cleaning technique of a transfer roller in an image forming apparatus in which a developer image is transferred from an image carrier to a sheet nipped and transported between the image carrier and the transfer roller.

2. Description of the Related Art

Hitherto, there is known an image forming apparatus in which a developer image is transferred from an image carrier to a sheet nipped and transported between the image carrier and a transfer roller.

In the case where cleaning of the transfer roller in the image forming apparatus as stated above is performed, it has been general that a bias voltage having the same polarity as the normal polarity of a developer is applied to the transfer roller, and unnecessary toner attached on the roller surface of the transfer roller is returned onto the image carrier.

However, in the related art, there is a case where it is impossible to completely clean the toner attached to the transfer roller, which increases due to an operating frequency in the image forming apparatus, the deterioration state of the developer, the occurrence frequency of sheet clogging, and the like. The defective cleaning as stated above causes a disadvantage (back stain) in which unnecessary toner is attached to the back surface of the sheet.

Besides, in the related art, there is also a problem that in the case where a toner charged with a polarity opposite to the normal polarity is attached on the transfer roller, it can not be removed.

### SUMMARY OF THE INVENTION

It is an object of an embodiment of the invention to provide a technique in which a cleaning process of a developer attached on a transfer roller can be effectively realized.

In order to solve the foregoing problem, according to an aspect of the invention, an image forming apparatus includes an instruction reception unit configured to receive information relating to an execution instruction of cleaning of a transfer roller in the image forming apparatus in which a developer image is transferred from an image carrier to a sheet nipped and transported between the image carrier and the transfer roller, a sheet supply control unit configured to perform sheet supply in a case where the instruction reception unit receives the information relating to the execution instruction of a cleaning mode, a timing determination unit configured to determine a timing when a sheet supplied by the sheet supply control unit exists at a specified transfer position where the developer image is transferred from the image carrier to the sheet nipped and transported between the image carrier and the transfer roller, and a voltage control unit configured to alternately switch between a voltage of a first polarity to be applied to the transfer roller when the developer image is transferred to the sheet from the image carrier at the transfer position and a voltage of a second polarity opposite to the first polarity and to apply the voltages to the transfer roller at the timing, which is determined by the timing determination unit, when the sheet exists at the specified transfer position.

Besides, according to another aspect of the invention, a cleaning method includes: receiving information relating to an execution instruction of cleaning of a transfer roller in an image forming apparatus in which a developer image is transferred from an image carrier to a sheet nipped and transported between the image carrier and the transfer roller, performing sheet supply in a case where the information relating to the execution instruction of a cleaning mode is received at the step of receiving the information, determining a timing when a sheet supplied at the step of performing the sheet supply exists at a specified transfer position where the developer image is transferred from the image carrier to the sheet nipped and transported between the image carrier and the transfer roller, and alternately switching between a voltage of a first polarity to be applied to the transfer roller when the developer image is transferred to the sheet from the image carrier at the transfer position and a voltage of a second polarity opposite to the first polarity and applying the voltages to the transfer roller at the timing, which is determined at the step of determining the timing, when the sheet exists at the specified transfer position.

Besides, according to still another aspect of the invention, a cleaning program causes a computer to execute: receiving information relating to an execution instruction of cleaning of a transfer roller in an image forming apparatus in which a developer image is transferred from an image carrier to a sheet nipped and transported between the image carrier and the transfer roller, performing sheet supply in a case where the information relating to the execution instruction of a cleaning mode is received at the step of receiving the information, determining a timing when a sheet supplied at the step of performing the sheet supply exists at a specified transfer position where the developer image is transferred from the image carrier to the sheet nipped and transported between the image carrier and the transfer roller, and alternately switching between a voltage of a first polarity to be applied to the transfer roller when the developer image is transferred to the sheet from the image carrier at the transfer position and a voltage of a second polarity opposite to the first polarity and applying the voltages to the transfer roller at the timing, which is determined at the step of determining the timing, when the sheet exists at the specified transfer position.

### DESCRIPTION OF THE DRAWINGS

FIG. 1 is an outer appearance view for explaining the whole structure of an image forming apparatus according to an embodiment of the invention.

FIG. 2 is a functional block diagram for explaining the image forming apparatus of the embodiment.

FIG. 3 is a schematic view showing a structure of a vicinity of an image carrier in the image forming apparatus of the embodiment.

FIG. 4 is a view showing an example of an instruction screen on which a user instructs execution of cleaning of a transfer roller.

FIG. 5 is a view showing an example of a screen displayed on a control panel 211 in a case where a counter value reaches a specified value.

FIG. 6 is a graph showing an example of a change in voltage value applied to a transfer roller 702 by a voltage control unit 106.

FIG. 7 is a view for explaining a state of a vicinity of a transfer position P just after cleaning of a transfer roller is executed.

FIG. 8 is a flowchart for explaining a flow of a process (cleaning method) in the image forming apparatus of the embodiment.

### DESCRIPTION OF THE EMBODIMENTS

Hereinafter, an embodiment of the invention will be described with reference to the drawings.

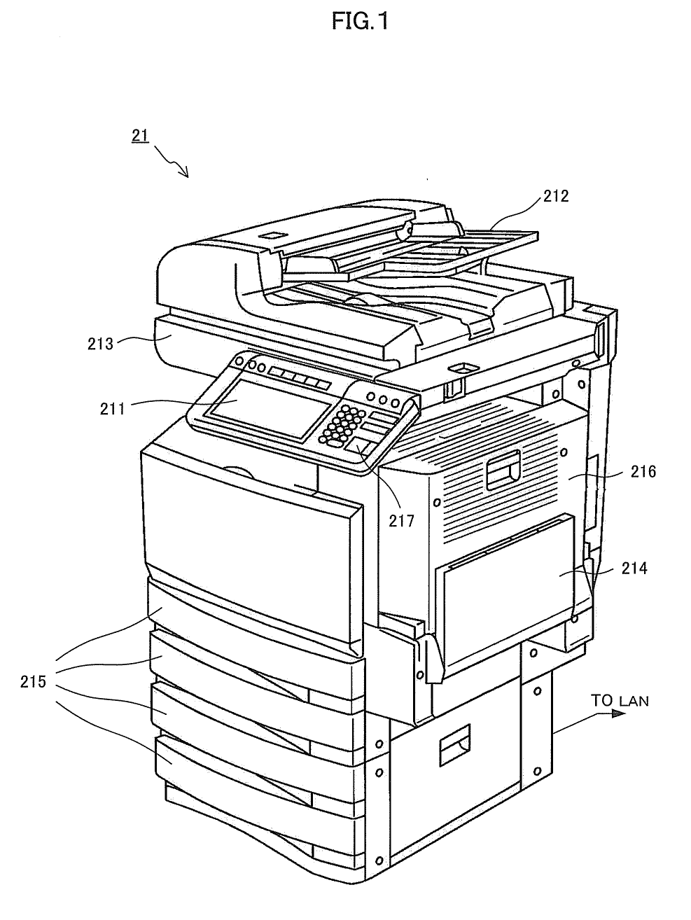

FIG. 1 is an outer appearance view for explaining the whole structure of an image forming apparatus according to the embodiment of the invention.

The image forming apparatus (MFP: Multi Function Peripheral) 21 of the embodiment includes a control panel 211, an automatic document feeder (so-called ADF) 212, an image reading unit 213, a manual feed tray 214, a cassette 215, an image forming unit 216 and a start button 217.

First, a copy operation in the image forming apparatus 21 of the embodiment will be described in brief.

The setting of a copy process is performed on the control panel 211 by the operation input of the user, and when the start button 217 is depressed, the copy process is started.

An original document continuously automatically transported by the automatic document feeder (so-called ADF) 212 to a position where an image can be read by the image reading unit 213 is scanned by the image reading unit 213.

The image forming unit 216 forms a toner image (developer image) to a sheet supplied from the manual feed tray 214 or the cassette 215 based on the image data scanned by the image reading unit 213.

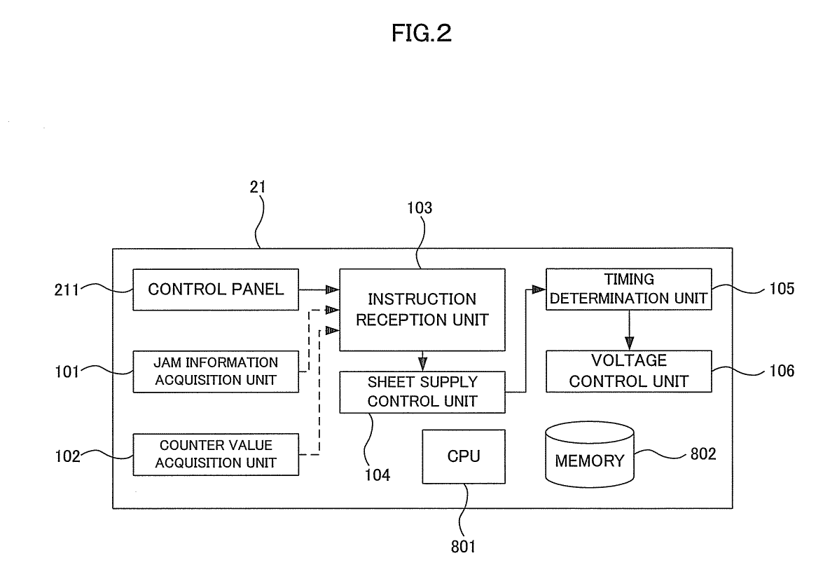

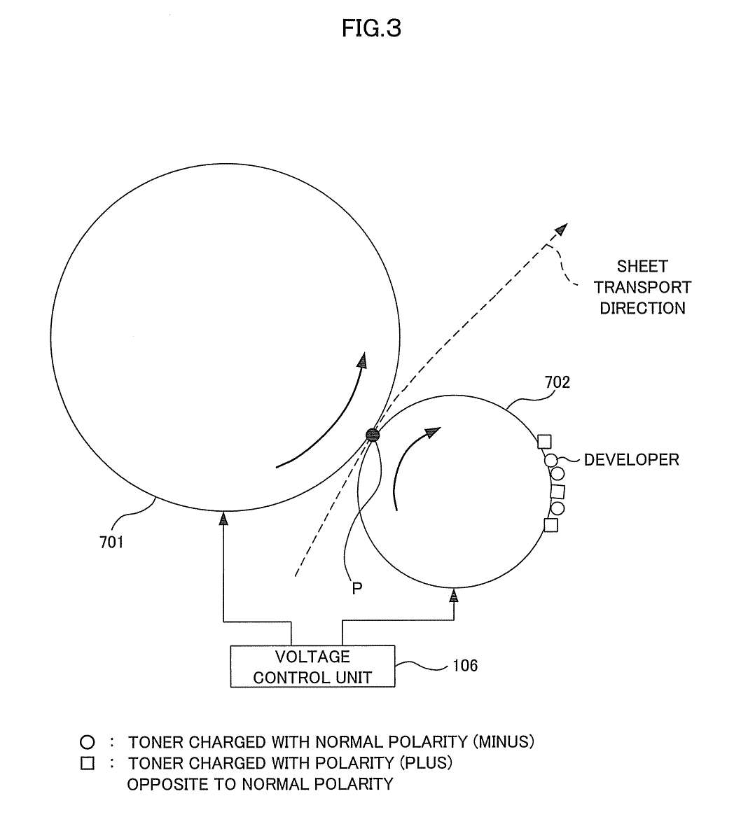

FIG. 2 is a functional block diagram for explaining the image forming apparatus of the embodiment, and FIG. 3 is a schematic view showing a structure of a vicinity of an image carrier in the image forming apparatus of the embodiment. Incidentally, FIG. 3 shows a state in which unnecessary toner is attached on the roller surface of a transfer roller. On the roller surface of the transfer roller in the drawing, a toner charged with a normal polarity (here, minus) is indicated by a circle, and a toner charged with a polarity (here, plus) opposite to the normal polarity is indicated by a square.

As shown in FIG. 3, in the image forming apparatus 21 of the embodiment, a toner image is transferred from an image carrier 701 to a sheet nipped and transported between the image carrier 701 and a transfer roller 702.

The image forming apparatus 21 of the embodiment of the invention includes a jam information acquisition unit 101, a counter value acquisition unit 102, an instruction reception unit 103, a sheet supply control unit 104, a timing determination unit 105, a voltage control unit 106, a CPU 801, and a MEMORY 802.

The jam information acquisition unit 101 acquires information (for example, jam detection information) relating to sheet clogging of a sheet to be transported to a specified transfer position P.

The counter value acquisition unit 102 acquires a counter value relating to the number of printed sheets in the image forming apparatus 21, which is obtained after the voltage control unit 106 last performed voltage application to the transfer roller 702 while alternately switching the polarities.

The instruction reception unit 103 receives information relating to an execution instruction of cleaning of the transfer roller 702.

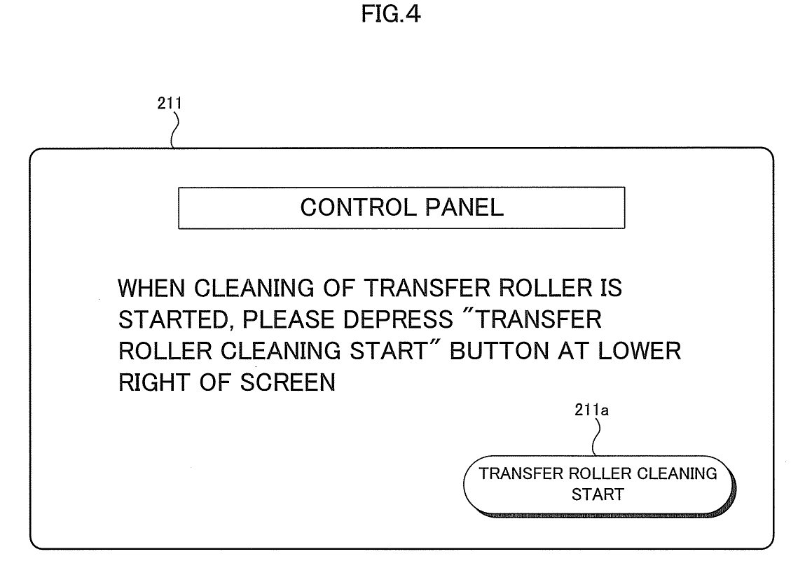

FIG. 4 is a view showing an example of an instruction screen on which the user instructs execution of cleaning of the transfer roller. In the case where the user desires to execute the cleaning of the transfer roller, the user depresses a “transfer roller cleaning start” button 211a provided on the screen (see FIG. 4) displayed on the control panel 211. The instruction reception unit 103 receives the operation input of depressing the “transfer roller cleaning start” button 211a as the information relating to the execution instruction of the cleaning of the transfer roller 702.

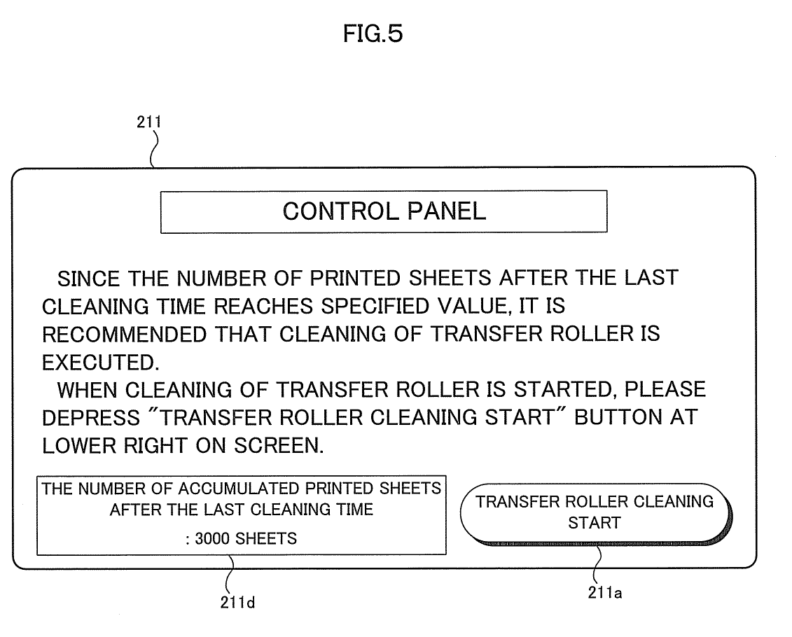

Besides, the instruction reception unit 103 may be structured such that in the case where the counter value relating to the number of printed sheets acquired by the counter value acquisition unit 102 reaches a specified value, it is assumed that the information relating to the execution instruction of the cleaning mode is received. FIG. 5 is a view showing an example of a screen displayed on the control panel 211 in the case where the counter value reaches the specified value (here, it is set to 3000 sheets as an example). In the screen display example shown in FIG. 5, in addition to the “transfer roller cleaning start” button 211a for performing the execution instruction of the cleaning, a counter value display unit 211d is displayed which shows a counter value indicating the number of accumulated printed sheets obtained after the last cleaning time. As stated above, since the structure is made such that the state that it is desirable to perform cleaning of the transfer roller is notified to the user based on the counter value, even in the situation where the user does not notice the stain of the transfer roller 702, the cleaning of the transfer roller 702 can be performed at a suitable timing.

In addition to this, the instruction reception unit 103 can also receive the information relating to sheet clogging acquired by the jam information acquisition unit 101 as the information relating to the execution instruction of the cleaning mode. In this case, the sheet clogging (jam) in the image forming apparatus 21 is detected by, for example, a not-shown jam detection sensor normally set in the image forming apparatus. In the case where the sheet clogging occurs, there is a case where a large amount of toner, which is originally to be transferred to the sheet, is erroneously transferred to the transfer roller 702 side. In such a case, the structure of the embodiment is effective in which a sheet is made to intervene between the image carrier and the transfer roller, and high voltages of a first and a second polarity are applied to the transfer roller.

In the case where the instruction reception unit 103 receives the information relating to the execution instruction of the cleaning mode, the sheet supply control unit 104 performs sheet supply from the manual feed tray 214 or the cassette 215 to the specified transport position P.

The timing determination unit 105 determines a timing when the sheet supplied by the sheet supply control unit 104 exists at the specified transfer position P where the toner image is transferred from the image carrier 701 to the sheet nipped and transported between the image carrier 701 and the transfer roller 702 (the sheet is nipped between the image carrier 701 and the transfer roller 702).

The voltage control unit 106 alternately switches between a voltage of a first polarity (plus) to be applied to the transfer roller 702 when the toner image is transferred from the image carrier 701 to the sheet at the transfer position P and a voltage of a second polarity (minus) opposite to the first polarity and applies the voltages to the transfer roller 702 at the timing, which is determined by the timing determination unit 105, when the sheet exists at the specified transfer position P. Incidentally, the voltage value applied by the voltage control unit 106 at this time is set to be higher than the voltage value of a bias voltage applied at the normal cleaning time of the transfer roller.

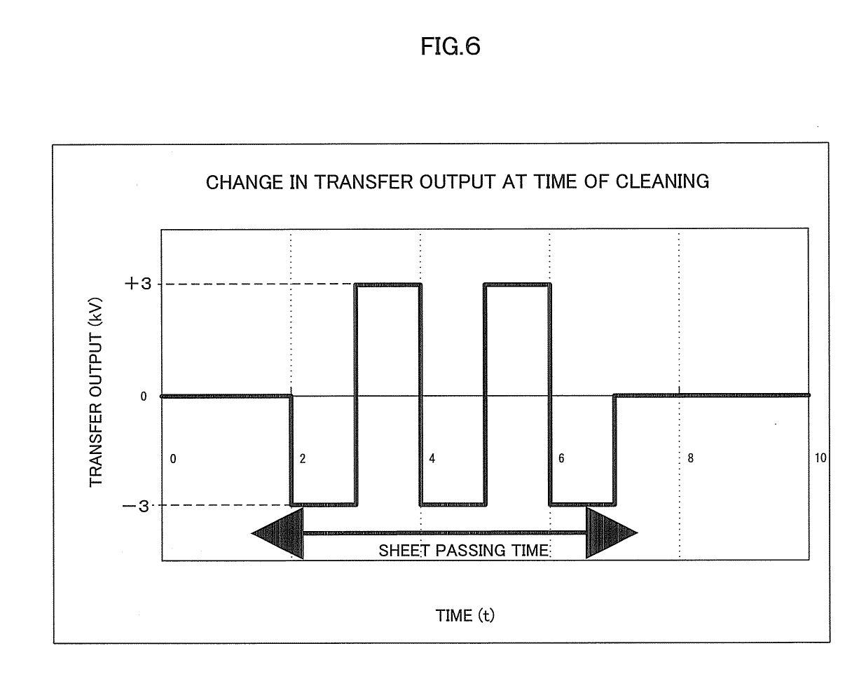

FIG. 6 is a graph showing an example of a change in voltage value applied to the transfer roller 702 by the voltage control unit 106. In the example shown in the drawing, the voltage value at the time when the voltage of the minus polarity as the first polarity is applied is set to −3 kV, and the voltage value at the time when the voltage of the plus polarity as the second polarity is set to +3 kV. Incidentally, when −3 kV is applied to the transfer roller 702, the voltage control unit 106 applies 0V to the image carrier, and when +3 kV is applied to the transfer roller 702, −500V is applied to the image carrier.

Specifically, in the period in which the polarities are alternately switched and the voltages are applied to the transfer roller 702, the voltage control unit 106 controls the applied voltages such that the voltage application to the transfer roller 702 starts when the polarity is the second polarity and ends when the polarity is the second polarity.

Here, since a polarity in the case where a toner as a developer is normally charged is “minus”, the polarity (first polarity) of the voltage applied to the transfer roller when the toner is transferred to the sheet is “plus”, and the opposite polarity (second polarity) is set to be “minus”.

When the voltage application is started when the polarity is the plus polarity, there is a fear that a so-called “memory image” remains on the image carrier surface of the image carrier. Then, in this embodiment, the voltage application is started when the polarity is the minus polarity, and the occurrence of the memory image is prevented.

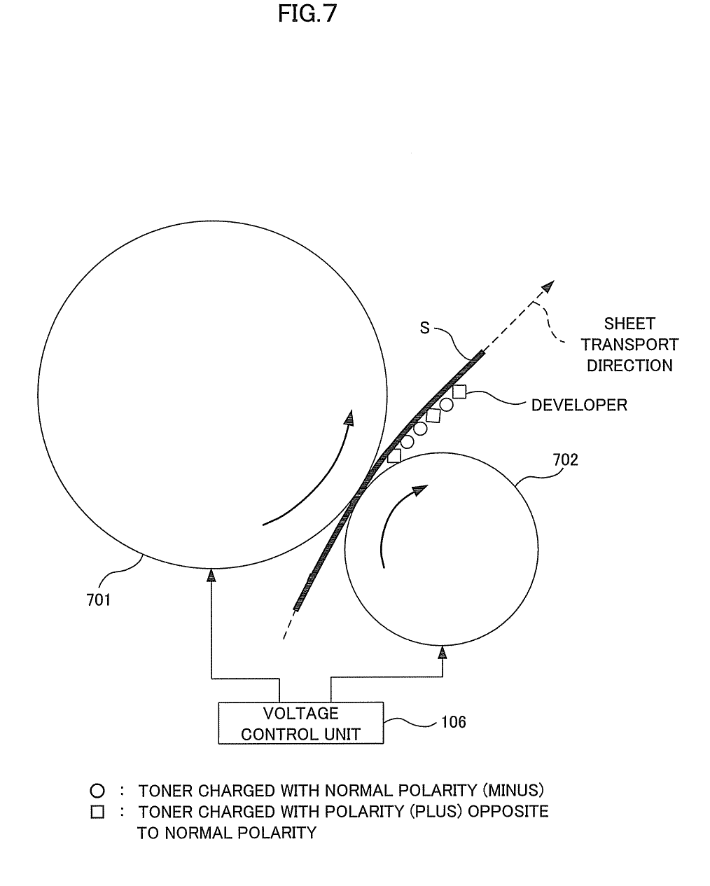

FIG. 7 is a view for explaining the state of the vicinity of the transfer position P just after the cleaning of the transfer roller is executed. As shown in the drawing, with respect to the toner attached to the roller surface of the transfer roller 702, not only the toner charged in minus as the normal polarity, but also the toner charged in plus is transferred to the sheet. In this way, the unnecessary toner transferred from the transfer roller 702 to the sheet is transported through a specified sheet transport path, and is discharged to the outside of the image forming apparatus 21.

The CPU 801 has a function to perform various processings in the image forming apparatus and has also a function to realize various functions by executing programs stored in the MEMORY 802. The MEMORY 802 includes, for example, a ROM or a RAM, and has a function to store various information and programs used in the image forming apparatus.

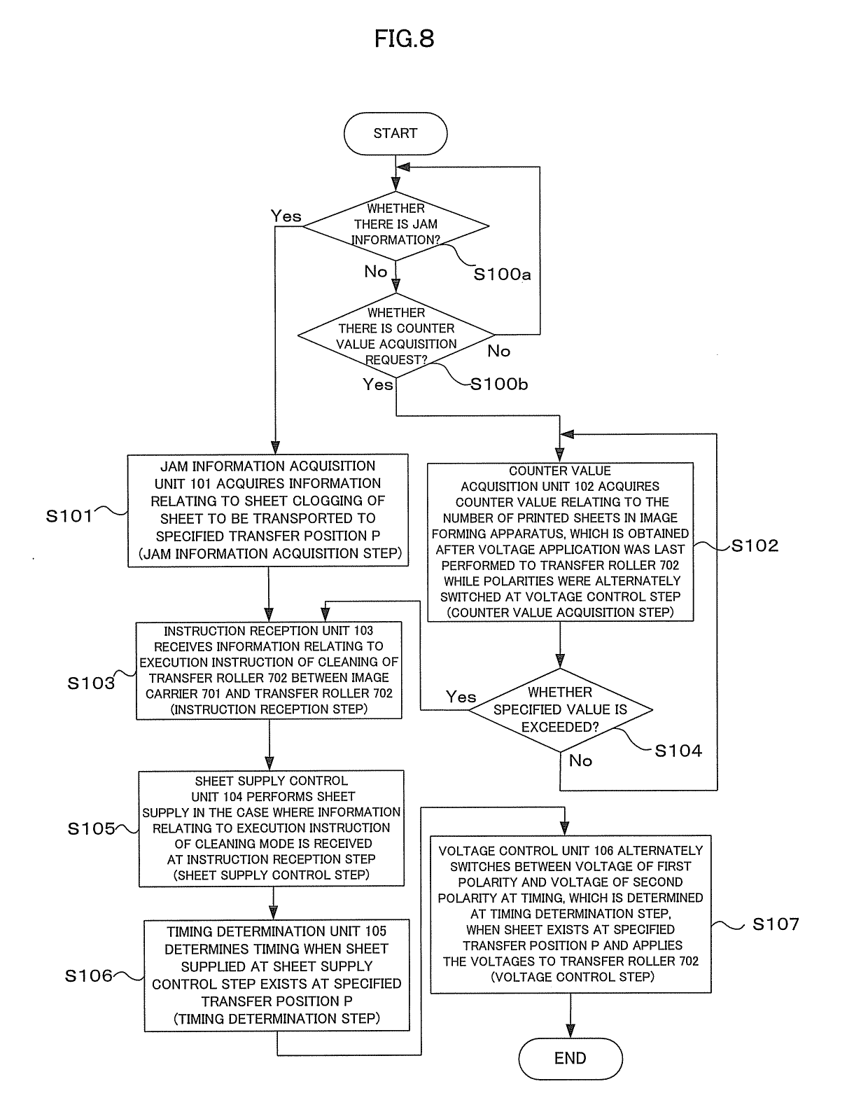

FIG. 8 is a flowchart for explaining a flow of a process (cleaning method) in the image forming apparatus of the embodiment.

In the case where a jam occurs in the image forming apparatus 21 (in the case where jam information is issued) (S100a, Yes), advance is made to S101 of the latter stage.

On the other hand, in the case where there is no jam information (S100a, No) and acquisition of a counter value is requested (S100b, Yes), advance is made to S102 of the latter stage.

The jam information acquisition unit 101 acquires information relating to sheet clogging of a sheet to be transported to the specified transfer position P (jam information acquisition step) (S101).

The counter value acquisition unit 102 acquires the counter value relating to the number of printed sheets in the image forming apparatus, which is obtained after the voltage application was last performed to the transfer roller 702 while the polarities were alternately switched at the voltage control step (counter value acquisition step) (S102).

The instruction reception unit 103 receives information relating to the execution instruction of cleaning of the transfer roller 702 in the image forming apparatus in which the toner image is transferred from the image carrier 701 to the sheet nipped and transported between the image carrier 701 and the transfer roller 702 (instruction reception step) (S103).

Incidentally, at the instruction reception step, the information relating to the sheet clogging acquired at the jam information acquisition step is received as the information relating to the execution instruction of the cleaning mode. Besides, at the instruction reception step, in the case where the counter value acquired at the counter value acquisition step reaches a specified value (S104, Yes), it is assumed that the information relating to the execution instruction of the cleaning mode is received.

In the case where the information relating to the execution instruction of the cleaning mode is received at the instruction reception step, the sheet supply control unit 104 performs the sheet supply (sheet supply control step) (S105).

The timing determination unit 105 determines a timing when the sheet supplied at the sheet supply control step exists at the specified transfer position P where the toner image is transferred from the image carrier 701 to the sheet nipped and transported between the image carrier 701 and the transfer roller 702 (timing determination step) (S106).

The voltage control unit 106 alternately switches between a voltage of a first polarity to be applied to the transfer roller 702 when the toner image is transferred from the image carrier 701 to the sheet at the transfer position P and a voltage of a second polarity opposite to the first polarity and applies the voltage to the transfer roller 702 at the timing, which is determined at the timing determination step, when the sheet exists at the specified transfer position P (voltage control step) (S107).

Incidentally, at the voltage control step here, in the period in which the polarities are alternately switched and the voltages are applied to the transfer roller 702, it is desirable that the applied voltages are controlled so that the voltage application to the transfer roller 702 is ended when the polarity is the second polarity. Besides, at the voltage control step, in the period in which the polarities are alternately switched and the voltages are applied to the transfer roller 702, it is desirable that the applied voltages are controlled so that the voltage application to the transfer roller 702 is started when the polarity is the second polarity.

The respective steps of the process in the image forming apparatus are realized by causing the CPU 801 to execute a cleaning program stored in the MEMORY 802.

As stated above, according to the embodiment, the voltage of the positive polarity and the voltage of the negative polarity are alternately applied to the transfer roller, so that the toner charged with the polarity opposite to the normal polarity can also be removed from the surface of the transfer roller, and it is possible to avoid the occurrence of a disadvantage such as toner stain of the back surface of the surface of the sheet on which the image is to be formed.

Besides, at the time of cleaning of the transfer roller, since the sheet is made to pass through between the image carrier and the transfer roller, even if the voltage value applied to the transfer roller is set to be high, an influence on the image carrier is small. By this, the bias voltage of the high voltage value can be applied, and the effective cleaning process can be realized.

Further, as described in the foregoing embodiment, since the instruction button for starting transfer roller cleaning is provided on the display screen of the control panel, or the structure is made such that the cleaning is started based on the counter value of the number of printed sheets or the jam detection result, the user himself/herself can easily perform the cleaning, and it becomes possible to reduce the number of times that a serviceman is called.

Incidentally, in this embodiment, although the example has been described in which the timing when the voltages of the alternately switched polarities are applied to the transfer roller is determined based on the timing such as the case where the cleaning execution instruction is issued by the user, the case where the sheet clogging is detected, or the case where the counter value relating to the number of printed sheets reaches the specified value, limitation is not always made to these. That is, any structure may be adopted as long as the cleaning operation of the transfer roller is executed in the state where the toner stain of the roller surface of the transfer roller reaches a certain level.

Besides, with respect to the voltage value applied to the transfer roller 702 by the voltage control unit 106, for example, switching is performed between the first polarity and the second polarity each time the roller surface of the transfer roller 702 makes a turn, and this switching cycle may be repeated four times.

Besides, in the example shown in FIG. 6, although the time in which the voltage value of the first polarity is applied and the time in which the voltage value of the second polarity is applied are set to the same time, no limitation is made to this. For example, in the state where there is a high possibility that a toner charged with a polarity opposite to the normal polarity is attached on the transfer roller, the time in which the second polarity for transferring the toner charged with the opposite polarity from the transfer roller 702 to the sheet is applied may be made long. Incidentally, in this embodiment, the time in which the voltage value of the first polarity is applied and the time in which the voltage value of the second polarity is applied are respectively set to be longer than the time required when the transfer roller 702 makes a turn.

Besides, in the example shown in FIG. 6, although the magnitude (amplitude) of the voltage value applied to the transfer roller 702 by the voltage control unit 106 is set to be the same value between the first polarity and the second polarity, in a state in which there is a high possibility that the toner charged with the opposite polarity to the normal polarity is attached on the transfer roller, the absolute value of the voltage value of the second polarity for transferring the toner charged with the opposite polarity from the transfer roller 702 to the sheet is made larger than the absolute value of the voltage value of the first polarity (that is, the absolute value of the voltage value of the voltage applied with the first polarity may be different from the absolute value of the voltage value of the voltage applied with the second polarity).

Besides, in the embodiment, although the example has been described in which the image carrier is the photoconductive body, no limitation is made to this, and it is needless to say that even if the image carrier is an intermediate transfer drum or an intermediate transfer belt, the same effect as the above embodiment can be obtained.

Besides, in the embodiment, although the example has been described in which in the case where toner is charged with the normal polarity, it is charged in minus, no limitation is made to this, and it is needless to say that the structure can be made such that the normal charge polarity of toner is plus.

In this embodiment, although the description has been given to the case where the function to carry out the invention is previously stored in the inside of the apparatus, no limitation is made to this, and the same function may be downloaded from a network, or a storage medium recording the same function may be installed in the apparatus. As the recording medium, any form may be adopted as long as the recording medium, such as a CD-ROM, can store a program and can be read by the apparatus. Besides, the function previously obtained by the installation or download as stated above may be such that the function is realized in cooperation with an OS (Operating System) of the inside of the apparatus.

Although the invention has been described in detail while using the specific embodiment, it would be apparent for one of ordinary skill in the art that various modifications and improvements can be made within the range not departing from the sprit and the scope of the invention.

As described above in detail, according to the invention, it is possible to provide the technique in which the cleaning process of the developer attached to the transfer roller can be effectively realized.

What is claimed is:

1. An image forming apparatus comprising:
an instruction reception unit configured to receive information relating to an execution instruction of cleaning of a transfer roller in the image forming apparatus in which a developer image is transferred from an image carrier to a sheet nipped and transported between the image carrier and the transfer roller;
a sheet supply control unit configured to perform sheet supply in a case where the instruction reception unit receives the information relating to the execution instruction of a cleaning mode;
a timing determination unit configured to determine a timing when a sheet supplied by the sheet supply control unit exists at a specified transfer position where the developer image is transferred from the image carrier to the sheet nipped and transported between the image carrier and the transfer roller; and
a voltage control unit configured to alternately switch between a voltage of a first polarity to be applied to the transfer roller when the developer image is transferred to the sheet from the image carrier at the transfer position and a voltage of a second polarity opposite to the first polarity and to apply the voltages to the transfer roller at the timing, which is determined by the timing determination unit, when the sheet exists at the specified transfer position.

2. The image forming apparatus according to claim 1, wherein in a period in which the polarities are alternately switched and the voltages are applied to the transfer roller, the voltage control unit controls the applied voltages to end the voltage application to the transfer roller when the polarity is the second polarity.

3. The image forming apparatus according to claim 1, wherein in a period in which the polarities are alternately switched and the voltages are applied to the transfer roller, the voltage control unit controls the applied voltages to start the voltage application to the transfer roller when the polarity is the second polarity.

4. The image forming apparatus according to claim 1, further comprising a jam information acquisition unit configured to acquire information relating to sheet clogging of a sheet to be transported to the specified transfer position,
wherein the instruction reception unit receives the information relating to the sheet clogging acquired by the jam information acquisition unit as the information relating to the execution instruction of the cleaning mode.

5. The image forming apparatus according to claim 1, further comprising a counter value acquisition unit configured to acquire a counter value relating to the number of printed sheets in the image forming apparatus, which is obtained after the voltage control unit last performed the voltage application to the transfer roller while alternately switching the polarities,
wherein in a case where the counter value acquired by the counter value acquisition unit reaches a specified value, the instruction reception unit assumes that the information relating to the execution instruction of the cleaning mode is received.

6. The image forming apparatus according to claim 1, wherein the first polarity is minus.

7. A cleaning method comprising:
receiving information relating to an execution instruction of cleaning of a transfer roller in an image forming apparatus in which a developer image is transferred from an image carrier to a sheet nipped and transported between the image carrier and the transfer roller;
performing sheet supply in a case where the information relating to the execution instruction of a cleaning mode is received at the step of receiving the information;
determining a timing when a sheet supplied at the step of performing the sheet supply exists at a specified transfer position where the developer image is transferred from the image carrier to the sheet nipped and transported between the image carrier and the transfer roller; and
alternately switching between a voltage of a first polarity to be applied to the transfer roller when the developer image is transferred to the sheet from the image carrier at the transfer position and a voltage of a second polarity opposite to the first polarity and applying the voltages to the transfer roller at the timing, which is determined at the step of determining the timing, when the sheet exists at the specified transfer position.

8. The cleaning method according to claim 7, wherein at the step of alternately switching, in a period in which the polarities are alternately switched and the voltages are applied to the transfer roller, the applied voltages are controlled to end the voltage application to the transfer roller when the polarity is the second polarity.

9. The cleaning method according to claim 7, wherein at the step of alternately switching, in a period in which the polarities are alternately switched and the voltages are applied to the transfer roller, the applied voltages are controlled to start the voltage application to the transfer roller when the polarity is the second polarity.

10. The cleaning method according to claim 7, further comprising acquiring information relating to sheet clogging of a sheet to be transported to the specified transfer position,
wherein at the step of receiving the information, the information relating to the sheet clogging acquired at the step of acquiring the information is received as the information relating to the execution instruction of the cleaning mode.

11. The cleaning method according to claim 7, further comprising acquiring a counter value relating to the number of printed sheets in the image forming apparatus, which is obtained after the voltage application was last performed to the transfer roller while the polarities were alternately switched at the step of alternately switching,
wherein at the step of receiving the information, in a case where the counter value acquired at the step of acquiring the counter value reaches a specified value, it is assumed that the information relating to the execution instruction of the cleaning mode is received.

12. The cleaning method according to claim 7, wherein the first polarity is minus.

13. A cleaning program for causing a computer to execute:
receiving information relating to an execution instruction of cleaning of a transfer roller in an image forming apparatus in which a developer image is transferred from an image carrier to a sheet nipped and transported between the image carrier and the transfer roller;
performing sheet supply in a case where the information relating to the execution instruction of a cleaning mode is received at the step of receiving the information;
determining a timing when a sheet supplied at the step of performing the sheet supply exists at a specified transfer position where the developer image is transferred from the image carrier to the sheet nipped and transported between the image carrier and the transfer roller; and
alternately switching between a voltage of a first polarity to be applied to the transfer roller when the developer image is transferred to the sheet from the image carrier at the transfer position and a voltage of a second polarity opposite to the first polarity and applying the voltages to the transfer roller at the timing, which is determined at the step of determining the timing, when the sheet exists at the specified transfer position.

14. The cleaning program according to claim 13, wherein at the step of alternately switching, in a period in which the polarities are alternately switched and the voltages are applied to the transfer roller, the applied voltages are controlled to end the voltage application to the transfer roller when the polarity is the second polarity.

15. The cleaning program according to claim 13, wherein at the step of alternately switching, in a period in which the polarities are alternately switched and the voltages are applied to the transfer roller, the applied voltages are controlled to start the voltage application to the transfer roller when the polarity is the second polarity.

16. The cleaning program according to claim 13, wherein the cleaning program causes the computer to further perform acquiring information relating to sheet clogging of a sheet to be transported to the specified transfer position,
wherein at the step of receiving the information, the information relating to the sheet clogging acquired at the step of acquiring the information is received as the information relating to the execution instruction of the cleaning mode.

17. The cleaning program according to claim 13, wherein the cleaning program causes the computer to further execute acquiring a counter value relating to the number of printed sheets in the image forming apparatus, which is obtained after the voltage application was last performed to the transfer roller while the polarities were alternately switched at the step of alternately switching,
wherein at the step of receiving the information, in a case where the counter value acquired at the step of acquiring the counter value reaches a specified value, it is assumed that the information relating to the execution instruction of the cleaning mode is received.

18. The cleaning program according to claim 13, wherein the first polarity is minus.
